(19) United States
(12) Patent Application Publication
(10) Pub. No.: US 2006/0289472 A1
(43) Pub. Date: Dec. 28, 2006

(54) Flexible heating mat and production method thereof

(76) Inventors: Jean-Claude Beisser, Riedisheim (FR); Jean-Paul Scherrer, Mulhouse (FR); Jean-Claude Beisser, I'Argentiere La Bossee (FR)

Correspondence Address: YOUNG & THOMPSON, 745 SOUTH 23RD STREET, 2ND FLOOR, ARLINGTON, VA, 22202, US

(21) Appl. No.: 10/539,411

(22) PCT Filed: Dec. 24, 2003
(86) PCT No.: PCT/FR03/03903

§ 371 Date: May 18, 2006

(30) Foreign Application Priority Data
Dec. 24, 2002 (FR) 02/16628

(51) Int. Cl. H05B 3/08

(52) U.S. Cl. 219/541

(57) ABSTRACT

A longitudinal flexible heating mat includes a thin conductive metal strip (3) which is intended to be supplied with electric current at the ends (C, D) thereof and which is trapped between two flexible, insulating sheets (1, 1′) . The conductive strip includes at least two elements (3a, 3b) which extend from one of the longitudinal ends (A) of the mat to the other longitudinal end (B) of same. The first ends (C, D) of the aforementioned elements are intended to be connected to respective electric power terminals, and the second ends (D, E) of the elements are free and intended to be connected to one another using connection members (7). The invention also relates to a method of producing one such mat.

The present invention relates to a device for heating, in particular, a floor, a ceiling or a wall of premises, this heating device being in the form of a flexible, tight mat adapted to be cut to the length desired by the user as a function of his needs. The present invention also relates to a method for producing such a flexible heating mat.

Heating devices of this type have already been proposed in the prior state of the art, which are constituted by two support sheets made of flexible, insulating and tight material between which is fixed a conductive and resistive metal strip which is folded so as to form successive lines separated by a given space. This strip is supplied with electric current at each of its ends and thus furnishes electric heating power which is a function of its length, its resistivity and its supply voltage.

A drawback of the afore-mentioned heating technique is that it requires individual production in the factory which is specific of each particular dimension of the desired heating panels.

The present invention has for its object to propose a heating mat of this type which, on the one hand, is easy and rapid to produce in the factory and which, on the other hand, allows its user to adapt it to his own needs by a simple operation of cut-out and of connection.

Under these conditions, the user will have available a heating device constituted by a wound mat presenting a determined width which he can cut out as desired in order to have the desired length available. He may also arrange the 25 breadths side by side when the width of the surface of use is greater than that of one breadth.

The present invention thus has for its object a flexible, longitudinal heating mat, constituted by a first and a second track, formed by a metal film intended to be supplied with electric current, by their respective upstream ends and which are trapped between two flexible, insulating sheets, characterized in that:
the first and second metal tracks are heating and extend in associated manner transversely over virtually the whole width of the mat and are distributed periodically in the longitudinal direction,
the downstream ends of the two tracks are free and intended to be connected to each other, before use, by connection means.

According to the invention, the tracks extend in associated manner transversely, in that the width, in the transverse direction, of the sum of these two tracks is substantially equal to the width of the mat.

In a first form of embodiment of the invention, the first and second tracks will form successive half-loops which will be imbricated in one another so that, in the longitudinal direction, there will be successively encountered, from the upstream end of the mat to the downstream end, a first track, then an alternation of two second tracks and two first tracks.

The tracks may also form successive half-loops constituted by transverse parts and longitudinal parts of smaller length, the transverse part of one of the tracks being completed to the value of the width of the mat by an adjacent transverse part of the other track. The configuration of the tracks will preferably be such that they will extend successively transversely and longitudinally from one end of the mat to the other while remaining parallel to one another.

The fixation of the two tracks on the support sheets may in particular be ensured by means of an adhesive, preferably of repositionable type.

In order to promote fixation of the mat according to the invention, particularly in slabs, the two flexible insulating sheets may be traversed by orifices disposed between the tracks.

The metal film used will preferably be constituted by aluminium and the width of the tracks will preferably be of the order of 2.5 cm, their thickness being of the order of 0.25 mm. The spacing of the tracks in the longitudinal direction will preferably be of the order of 1.5 cm, and in the transverse direction, of the order of 1 cm.

Furthermore, in order to promote positioning of the connection means, one of the flexible insulating sheets may be pierced with an orifice giving access to the two ends of the tracks. This access orifice will make it possible to ensure the electrical connection of this track with a conductor, preferably a flat conductor.

In a particularly interesting form of embodiment of the invention, the geometry of the tracks may be designed so that the peel, i.e. that part of the metal strip remaining after cut-out, may itself constitute a heating mat. To that end, the geometry of the tracks will be designed so that the intermediate mat comprises two series of tracks associated in two's, so that there will be successively encountered, in alternation from one end of the mat to the other, two first tracks of the first series, a first track of the second series, a second track of the first series, two second tracks of the second series, a second track of the first series, and a first track of the second series.

The present invention also relates to a method for producing a flexible heating mat in the form of a longitudinal strip forming a breadth of given width, constituted by two conductive tracks supplied with electric current by their respective upstream ends and which are trapped between two flexible, insulating support sheets, characterized in that it comprises the steps consisting in:
fixing a flexible metal sheet on a flexible, electrically insulating support sheet,
cutting out the metal sheet over at least its thickness, so as to form therein two heating tracks, the upstream ends of these tracks being intended to be connected to respective terminals supplying electric current, and the downstream ends of these elements being free and intended to be connected to each other, before use, by connection means,
eliminating the peel resulting from this cut-out,
fixing a second flexible, insulating support sheet on the other face of the tracks so that the latter are sandwiched between the two support sheets.

According to the invention, the peel may be extracted by exerting thereon a simple traction or, when it is fragile, by gluing on the latter a flexible tear-off sheet coated with a glue presenting an adhesive power greater than that of the metal sheet on the support sheet.

At least the cut-out step will preferably be carried out with the aid of a continuously operating rotary machine.

A form of embodiment of the present invention will be described hereinafter by way of non-limiting example, with reference to the accompanying drawings, in which:

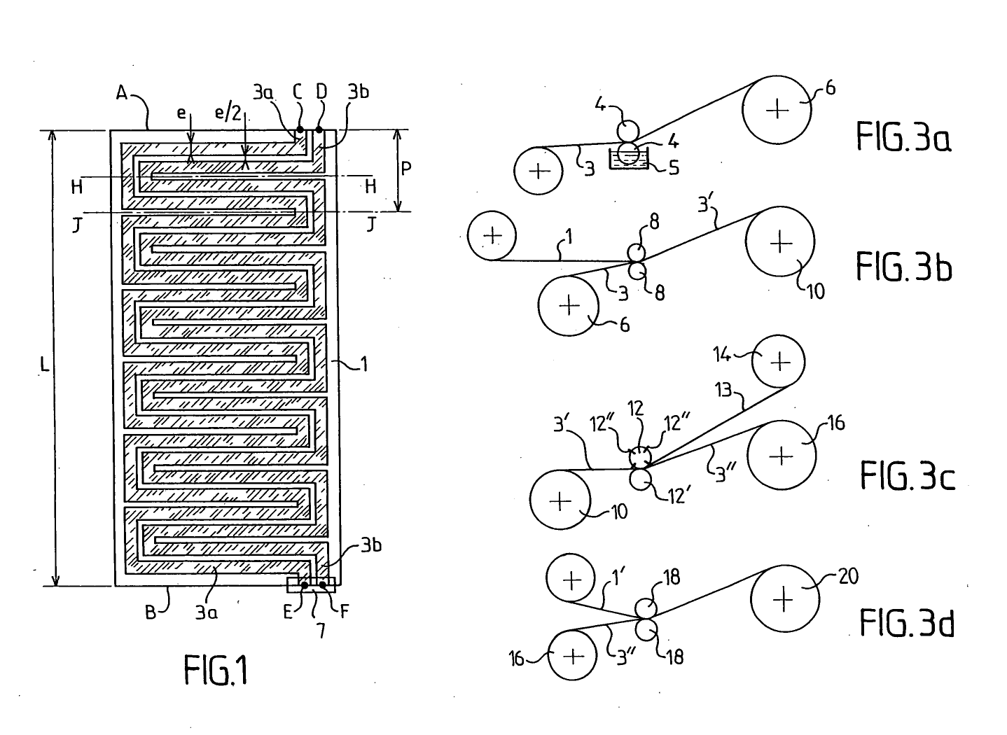

FIG. 1 is a plan view of an example of embodiment of a flexible heating mat according to the invention.

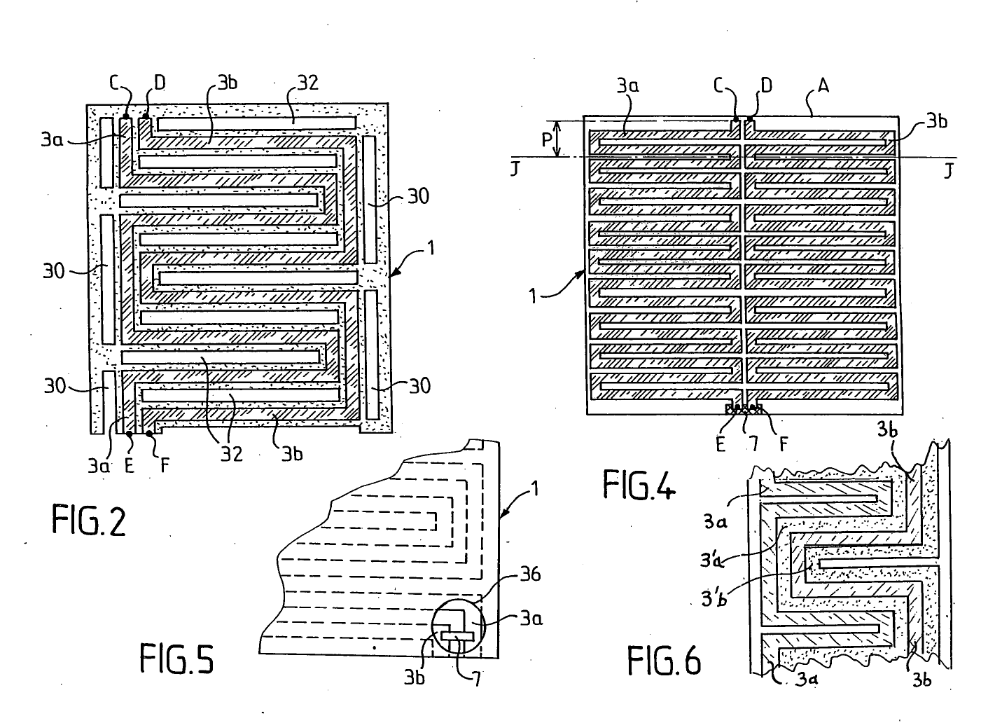

FIG. 2 is a variant embodiment of the flexible heating mat according to the invention shown in FIG. 1.

FIGS. 3a to 3d are schematic views showing the different steps of an example of method for producing the flexible heating mat according to the invention.

FIG. 4 is a plan view of another form of embodiment of a flexible heating mat according to the invention.

FIGS. 5 and 6 are partial plan views of two variant embodiments of the invention.

The flexible heating mat according to the invention which is shown in

FIG. 1 is composed of a support sheet 1 which is constituted by a wound longitudinal strip, made of a flexible and electrically insulating material such as in particular a polyvinyl chloride (hereinafter called PVC) film, of which the thickness is about 0.25 mm and width is of the order of 1.5 m, on which have been fixed, particularly by means of a repositionable adhesive glue, two electrically conductive tracks 3a, 3b, particularly metal strips with a thickness of the order of 0.5 mm and a width of 40 mm. The conductive metal used will for example be aluminium which presents the advantages of being of an appropriate conductivity and of easily lending itself to producing tracks of small thickness due to its good ductility.

The conductive tracks 3a, 3b are disposed so that they extend both along the length of the support sheet 1 but also over virtually the whole width thereof apart from a margin, so that the heat which will be delivered by these conductive tracks is distributed uniformly over the whole surface of the mat.

As shown in FIG. 1, in this form of embodiment of the invention, the tracks 3a and 3b depart from an upstream end A of the mat to go towards the downstream end B thereof. For dielectric reasons, the space included between two tracks is arranged to be of the order of about half the width e of the latter, or a distance e/2. All along their path, the two tracks remain parallel to each other while maintaining such a distance e/2 therebetween.

It is thus ascertained that the general configuration of these tracks 3a, 3b on the support sheet 1 is of repetitive form, the distance separating, lengthwise of the mat, the same configuration of tracks constituting the pitch P thereof. The support sheet 1 and the conductive tracks 3a, 3b are covered with another flexible, electrically insulating support sheet whose constitution may for example be identical to that of the support sheet 1, this sheet being able to be fixed on the mat 1 and on the conductive tracks 3a, 3b by any appropriate means and in particular by means of an adhesive glue.

The heating mat according to the invention may be implemented as described hereinafter. The two upstream ends C and D of the conductive tracks 3a, 3b are respectively connected to two terminals supplying electric current, preferably a low voltage electric current, of the order of 50 volts.

As for the other ends, or downstream ends E and F, of these respective tracks, they are connected together by a conductive bridge 7, so as to ensure the electrical continuity of the circuit formed by the two tracks 3a and 3b, the internal resistance of this circuit forming the electrical heating resistance of the mat.

As a function of the surface and geometry of the room which it is desired to heat, the user will have the possibility of cutting the heating mat to the length closest to the length of the room forming a whole multiple of the pitch P.

Under these conditions, it will be understood that the most interesting configuration of the arrangement of the conductive tracks 3a, 3b on the support sheet 1 will be the one making it possible to obtain the pitch P which is the most reduced possible, this allowing the user to obtain a better precision in his cut-out.

The flexible heating mat according to the invention is thus particularly interesting in that it allows a very great adaptability concerning the length of the room to be heated. Of course, concerning the width thereof, the user will have the possibility of arranging a plurality of strips side by side, as a function of this width.

Once the length L of the mat is determined, the user will cut out the latter then ensure the connection of the two free downstream ends E and F in order to ensure the electrical continuity, and this by means of a conductive bridge 7 or a weld.

In the present form of embodiment of the invention, the configuration shown even allows the user to effect his cut-out according to each half-value P/2 of the pitch P (dashed and dotted line H-H) or according to a whole pitch (dashed and dotted line J-J).

The present form of embodiment is interesting in that, on the one hand, it minimizes the value of the electric field created by the tracks 3a, 3b when they have a current passing therethrough, and, on the other hand, by reason of the simplicity of the configuration, it allows simple production of the cut-out tool, and in particular of the threads made on a cut-out cylinder.

It is of course possible according to the invention to adopt another configuration of arrangement of the conductive tracks 3a and 3b on the support sheet 1. For example, FIG. 2 shows another arrangement of these tracks in which the two tracks 3a and 3b extend transversely in associated manner, i.e. the width in the transverse direction of the two tracks placed end to end is equal to substantially the width of the mat. More precisely, the tracks 3a and 3b depart from the middle of the upstream end A of the mat in order then to move away from each other and be directed towards each of the two transverse edges thereof, and then move closer to the centre and depart again towards the lateral edges.

This FIG. 2 shows the pitch P of this configuration, evidencing the zones of cut-out, i.e. where the user will have the possibility of effecting the cut-out of the mat, and of having available the other two ends E, F of the conductive tracks 3a, 3b, or downstream end, that he may easily join by a connection in order to respect the continuity of the electric circuit thus constituted.

The present invention is also particularly interesting in that it lends itself easily to industrial production making it possible to produce such a flexible heating mat at particularly competitive cost prices.

In accordance with the method according to the invention, of which the different steps are schematically shown in FIGS. 3a to 3d, one starts firstly from a metal sheet 3 in strip form, particularly of aluminium, of which the width is substantially equal to the width of the mat, or breadth, once terminated. This strip 3 is admitted between two cylinders 4 which deposit thereon an adhesive film 5. The strip 3 thus treated is then wound so as to form a roll 6.

During the second step, represented in FIG. 3b, the metal strip 3 previously coated with the adhesive and the support sheet 1 made of PVC are admitted between presser cylinders 8, so as to join them one to the other, then the assembly 3′ is wound on a roll 10.

During the third step, represented in FIG. 3c, cut-out of the metal strip 3 glued on the PVC support sheet 1 is ensured so as to form the tracks. To that end, the mat 3′ issuing from the roll 10 is admitted between two cylinders, namely a cut-out cylinder 12 and its counter-part 12′. The cut-out cylinder 12 is, in known manner, provided with cut-out threads 12″ which reproduce the chosen configuration of the tracks represented for example in FIGS. 1 or 2, the depth of the cut-out threads 12″ being such that only the metal strip is cut out during this operation. Means, of known type, are provided on the cut-out machine in order to eliminate the peel 13, i.e. the elements of the conductive strip 4 which it is desired to eliminate, and which are extracted on a peel roller 14. As for the mat 3″, which is then constituted by the support sheet 1 and the heating tracks 3a and 3b, it is then wound on a roller 16.

During the fourth step, or ultimate step, represented in FIG. 3d, the mat 3″ wound on the roller 16 is admitted, jointly with the second support sheet 1′, between two cylinders 18 which ensure join thereof, the resultant definitive mat then being wound on a roller 20.

It will be understood that such a method of production is particularly interesting insofar as it can be carried out on existing gluing and cut-out machines able to ensure a particularly high output.

It is, of course, possible according to the invention to resort to other methods of production of continuous, or even discontinuous type.

The flexible heating mat thus obtained may be used for heating both the floor or the ceiling and the walls of premises. Its use for heating the floor is particularly interesting insofar as it is easy to constitute a mat which is totally tight to liquids or to gas, this rendering it particularly interesting in particular for heating swimming pools.

In the form of embodiment shown in FIG. 4, the recto (1) and verso (1′) support sheets of the mat comprise longitudinal (30) and/or transverses (32) perforations promoting adhesion of the flexible mat with the elements constituting a layer of cement or a wall covering.

As shown in FIG. 5, the positioning of the connection means between the ends of the tracks 3a and 3b, which is necessary for establishing the electrical continuity, will be facilitated by cutting out an orifice 36 in one of the support sheets 1 or 1′. Said orifice may be obtained by employing a manual or automatic cut-out tool which will penetrate in the sheet over a depth equal to its thickness, this then making it possible to detach the internal surface, thus giving access to the two ends of the elements 3a and 3b, on which the conductive bridge 7 will for example be welded. The same means may be used for ensuring supply of electric current of the mat on the upstream ends C and D thereof. The electrical supply may furthermore be effected by means of flat electric conductors, or for example insulated conductive plaitings.

The flexible heating mat according to the invention has been described in the case of using a two-phase current employing two strips. Of course, the present invention is applicable to polyphase currents and the number n of loop elements necessary for constituting the appropriate circuits will in that case be employed.

The extraction of the peel obtained during cut-out of the metal mat may be effected in different manners. It may firstly be torn off by effecting a simple traction thereon.

It is also possible for example to apply on the metal strip, after it has been cut out, a flexible tear-off sheet made of any polymer and which comprises on one of its faces a layer of adhesive glue of which the shape corresponds to that of the peel. The adhesive used will be chosen so that its attractive power is greater than that of the adhesive used for fixing the metal strip on the PVC film. The adhesive of the extraction mat is thus applied on the peel then a traction is exerted on the extraction mat, preferably with a force of component perpendicular to the peel, so that, during this effort, the extraction mat tears the peel from the PVC film on which it was fixed.

In an interesting variant of the invention shown in FIG. 6, the tracks will be given a geometry such that, in intermediate manner, the mat will comprise two series of two tracks. It will in that case thus be possible to use the peel glued on the flexible tear off sheet as a second heating mat. To that end, there may be used as flexible catching sheet a sheet of the same nature as that of the support sheet of the metal film. FIG. 6 thus shows two series of two tracks, namely a first series constituted by tracks 3a and 3b and a second series constituted by tracks 3′a and 3′b. In this way, there are successively encountered, in alternation from one end of the mat 1 to the other, two first tracks 3a of the first series, a first track 3′a of the second series, a second track 3b of the first series, two second tracks 3′b of the second series, a second track 3b of the first series, and a first track 3′a of the second series.

In another form of embodiment of the invention, and in order to facilitate cut-out of the metal mat and avoid the somewhat elastic character of the PVC layer, the metal mat will be glued on a thin, non-elastic film, particularly made of polyethylene. Once the operation of cut out is effected, there will be glued on the thin polyethylene film a support film which is more solid and thicker, particularly of PVC type. There will then remain to coat the cut out aluminium film with a second support film.

As described hereinabove, the present heating mat according to the invention is applicable to the heating of premises by disposing it over all or part of the floor and/or the walls. However, it is also applicable to other types of implementation such as for example the heating of vehicle interiors. To that end, mat elements whose outer shape follows those of the inner panels constituting the interior of a vehicle are disposed on said panels, or are disposed inside them, particularly so that their heating element is disposed at a short distance from their inner wall.

1. Flexible, longitudinal heating mat, constituted by a first and a second track, formed by a metal film, intended to be supplied with electric current, by their respective upstream ends (C, D) and which are trapped between two flexible, insulating sheets (1, 1′), characterized in that:
the first and second metal tracks are heating and extend in associated manner transversely over virtually the whole width of the mat and are distributed periodically in the longitudinal direction,
the downstream ends (D, E) of the two tracks are free and intended to be connected to each other, before use, by connection means (7).

2. Mat according to claim 1, characterized in that the first and second tracks form successive half-loops which are imbricated in one another so that, in the longitudinal direction, there will be successively encountered, from the upstream end of the mat to the downstream end, a first track, then an alternation of two second tracks and two first tracks.

3. Mat according to claim 1, characterized in that the tracks form successive half-loops constituted by transverse parts and longitudinal parts of smaller length, the transverse part of one of the tracks being completed to the value of the width of the mat by an adjacent transverse part of the other track.

4. Mat according to claim 3, characterized in that the configuration of the tracks is such that they extend successively transversely and longitudinally from one end (A) of the mat to the other (B) while remaining parallel to one another.

5. Mat according to claim 1, characterized in that the tracks are fixed on at least one of the flexible support sheets (1, 1′) by adhesive means.

6. Mat according to claim 5, characterized in that the adhesive used is of repositionable type.

7. Mat according to claim 1, characterized in that the two flexible insulating sheets (1, 1′) are traversed by orifices (30, 32) disposed between the tracks.

8. Mat according to claim 1, characterized in that one of the flexible insulating sheets (1, 1′) is pierced with an orifice (3b) giving access to one of the ends of at least one track.

9. Mat according to claim 8, characterized in that the orifice giving access to a track is intended for the electrical connection of a flat conductor on said track.

10. Mat according to claim 1, characterized in that the metal film is an aluminium film.

11. Mat according to claim 1, characterized in that the width of the mat is of the order of 0.5 m.

12. Mat according to claim 1, characterized in that the width of the tracks is of the order of 2.5 cm, and their thickness of the order of 0.25 mm.

13. Mat according to claim 1, characterized in that the space included between the tracks (3a, 3b) is equal to substantially half the width (e) thereof.

14. Mat according to claim 13, characterized in that the spacing of the tracks in the longitudinal direction is of the order of 1.5 cm.

15. Mat according to claim 1, characterized in that the spacing of the tracks in the transverse direction is of the order of 1 cm.

16. Intermediate mat according to claim 2, characterized in that it comprises two series of tracks associated in two's.

17. Intermediate mat according to claim 16, characterized in that there are successively encountered, in alternation from one end of the mat to the other:
two first tracks of the first series,
a first track of the second series,
a second track of the first series,
two second tracks of the second series,
a second track of the first series, and
a first track of the second series.

18. Method for producing a flexible heating mat in the form of a longitudinal strip forming a breadth of given width, constituted by two conductive tracks (3a, 3b) supplied with electric current by their respective upstream ends (C, D) and which are trapped between two flexible, insulating support sheets (1, 1′), characterized in that it comprises the steps consisting in:
fixing a flexible metal sheet (3) on a flexible, electrically insulating support sheet (1),
cutting out the metal sheet (3) over at least its thickness, so as to form therein two heating tracks (3a, 3b), the upstream ends (C, D) of these tracks (3a, 3b) being intended to be connected to respective terminals supplying electric current, and the downstream ends (E, F) of these elements (3a, 3b) being free and intended to be connected to each other, before use, by connection means (7),
eliminating the peel (13) resulting from this cut-out,
fixing a second flexible, insulating support sheet (1′) on the other face of the tracks (3a, 3b) so that the latter are sandwiched between the two support sheets (1, 1′).

19. Method according to claim 18, characterized in that the peel is extracted by gluing on the latter a flexible tear-off sheet coated with a glue presenting an adhesive power greater than that of the metal sheet on the support sheet.

20. Method according to claim 18, characterized in that at least the cut-out step is carried out with the aid of a continuously operating rotary machine.

21. Method according to claim 19, characterized in that at least the cut-out step is carried out with the aid of a continuously operating rotary machine.
